(19) United States
(12) Patent Application Publication
(10) Pub. No.: US 2003/0020944 A1
(43) Pub. Date: Jan. 30, 2003

(54) Printer pausing and reordering

(75) Inventors: Kulvir Singh Bhogal, Fort Worth, TX (US); Ishmael Nizamudeen JR., Austin, TX (US); Mandeep Singh Sidhu, Pflugerville, TX (US); Baljeet Singh Baweja, Austin, TX (US)

Correspondence Address: STREETS & STEELE, 13831 NORTHWEST FREEWAY, SUITE 355, HOUSTON, TX, 77040, US

(73) Assignee: INTERNATIONAL BUSINESS MACHINES CORPORATION, ARMONK, NY

(21) Appl. No.: 09/859,289

(22) Filed: May 17, 2001

(51) Int. Cl. G06F 15/00; B41J 1/00

(52) U.S. Cl. 358/1.15

(57) ABSTRACT

Printer handler of a computer operating system for managing print jobs, including user rescheduling of one or more of the print jobs into a second scheduled print order. The printer handler identifies a first print job that is printing and the last page of that job that has been, or is still being, printed. The printer handler then instructs the print device to complete the printing of the current page in the current print job and to return the remaining portion of the first print job to the queue. Optionally, the printer handler causes a separator page to be printed before and after the intervening print job to facilitate separation of the print jobs. The next print job in the print queue is sent by the printer handler to the print device to be printed, before resuming printing of the first print job without duplicating any pages previously printed.

### BACKGROUND OF THE INVENTION

1. Field of the Invention

This invention generally relates to improvements in computer systems and, more particularly, to operating system software for printing documents.

2. Description of the Related Art

One of the most important aspects of a modern computer system is the ability to generate a “hard” copy of textual information or graphics that can be manipulated by the computer, visually displayed and stored. In order to accomplish this task, a computer system generally includes a printing device that is electrically connected to the computer system and controlled by it in order to generate a permanent image on a selected medium. Examples of printing devices in common use are dot matrix, ink jet and laser printers that fix permanent images on paper under control of the computer. Although paper is the most common medium, other media are often used, such as photographic film.

In order to print a document that is displayed on the monitor or stored within the memory, several actions must take place. First, since the print medium generally has a fixed size, the printable information must be divided into pieces that are small enough to fit on the selected medium, a process that is called pagination. In addition, the information may need to be reformatted from the format in that it is either displayed or stored into a format that is suitable for controlling the printing device to actually perform the printing on the medium. The reformatting in this latter step may include the insertion of control commands into the printable information in order to control the printing device. These added commands may, for example, include such commands as carriage returns, line feeds, form feeds, spaces and font information, all of that format the printable information. The reformatting may also include a conversion step in which a graphical display is converted into the form used by the printing device.

The pagination and reformatting necessary to convert the printable information into a form that can be printed on a given printing device is generally performed by software programs running within the computer system. Software programs operating on a computing system generally can be categorized as either operating systems or application programs. Operating systems are usually specific to a type of computer system and consist of a collection of utility programs that enable the computer system to perform basic operations, such as storing and retrieving information on a peripheral disk memory, displaying information on an associated video display, performing rudimentary file operations including the creation, naming and renaming of files and, in some cases, performing diagnostic operations in order to discover or recover from malfunctions.

By itself, the operating system generally provides only very basic functions and must be accompanied by an application program. The application program interacts with the operating system to provide much higher-level functionality and a direct interface with the user. During the interaction between the application program and the operating system, the application program typically makes use of operating system functions by sending a series of task commands to the operating system that then performs the requested tasks. For example, the application program may request that the operating system store particular information on the computer disk memory or display information on the video display.

Regardless of whether the printer software is provided by the application program, the operating system, or some combination, the functionality of the printer software, and consequently the functionality of the printer, has been limited. In particular, printer software has been substantially limited to addressing the basic communications of formatting and pagination for a particular printer, or the notification of printer status or print job status to the user. While these functions are useful or necessary, they do not provide the user with much print management capabilities. A “pause” print jobs command is one of the few functions that are typically provided. However, this “pause” function is directed at pausing the entire print queue.

Therefore, there is a need for a method or system providing more print management capabilities. It would be desirable to have a method or system that could provide an increased level of user control over print jobs or other aspects of the printing process. More particularly, it would be desirable to have a method or system that allowed user prioritization of print jobs. It would be most desirable if the method or system were compatible with existing applications.

### SUMMARY OF THE INVENTION

The present invention provides a method for managing a plurality of print jobs scheduled to be printed. The method comprises displaying the print jobs in a scheduled print order, rescheduling the print jobs in a second scheduled print order, and printing the prints jobs in the second scheduled print order. Preferably, the print jobs are rescheduled in response to commands initiated by a user, such as the user prioritizing the print jobs. It is also preferred for the plurality of print jobs to be generated using one or more application programs running in a computer that is in communication with one or more printers. The method may further comprise spooling the plurality of print jobs onto a storage device of the computer to form a scheduled print order.

More particularly, the method may include pausing at least one of the print jobs, and printing another of the print jobs. Accordingly, the method allows for resuming printing of the paused print job. Preferably, a separator page with print job information is printed each time a print job is resumed, most preferably before and after the step of printing another of the print jobs. It is an optional feature to display print status information to the user during a print operation.

The invention also provides a method for pausing printing of a first multiple-page print job. This method includes printing a first portion of the first print job, receiving a second print job, identifying and queing a second unprinted portion of the first print job, printing the second print job, and then printing the second unprinted portion of the first print job. The method may further comprise allowing a last page in the first portion of the first print job to complete printing, wherein the second unprinted portion of the first print job is identified as everything in the first print job following the last page to complete printing before the pause command was issued.

The foregoing and other objects, features and advantages of the invention will be apparent from the following more particular description of a preferred embodiment of the invention, as illustrated in the accompanying drawing wherein like reference numbers represent like parts of the invention.

### BRIEF DESCRIPTION OF THE DRAWINGS

FIG. 1 is a block diagram of a computer system on which the present invention may be carried out.

FIG. 2 is a block diagram of modified computer system in which the operating system controls operation of a print device.

FIG. 3 is a block diagram of the information paths by which a print job is channeled to a print device.

FIG. 4 is a flowchart illustrating the steps of pausing a first print job or advancing a second print job in accordance with a preferred embodiment.

### DETAILED DESCRIPTION

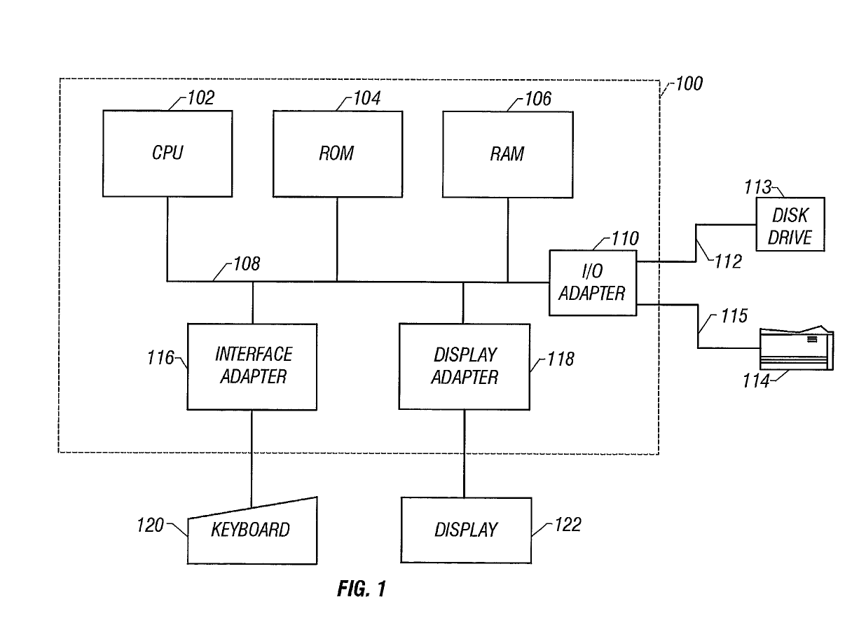

FIG. 1 is a block diagram of a personal computer, such as the IBM PS/2 or Macintosh computer, having a typical hardware configuration that is suitable for carrying out the present invention. The computer 100 is controlled by a central processing unit 102, which may be a conventional microprocessor; a number of other units, all interconnected via a system bus 108, are provided to accomplish specific tasks. Although a particular computer may only have some of the units illustrated in FIG. 1 or may have additional components not shown, most computers will include at least the units shown.

Specifically, computer 100 includes a random access memory (RAM) 106 for temporary storage of information, a read only memory (ROM) 104 for permanent storage of the computer's configuration and basic operating commands and an input/output (I/O) adapter 110 for connecting peripheral devices such as a disk unit 113 and printer 114 to the bus 108, via cables 112 and 115, respectively. A user interface adapter 116 is also provided for connecting input devices, such as a keyboard 120, and other known interface devices including mice, speakers and microphones to the bus 108. Visual output is provided by a display adapter 118 that connects the bus 108 to a display device 122 such as a video monitor. The workstation has resident thereon and is controlled and coordinated by operating system software such as the Microsoft Windows® operating system.

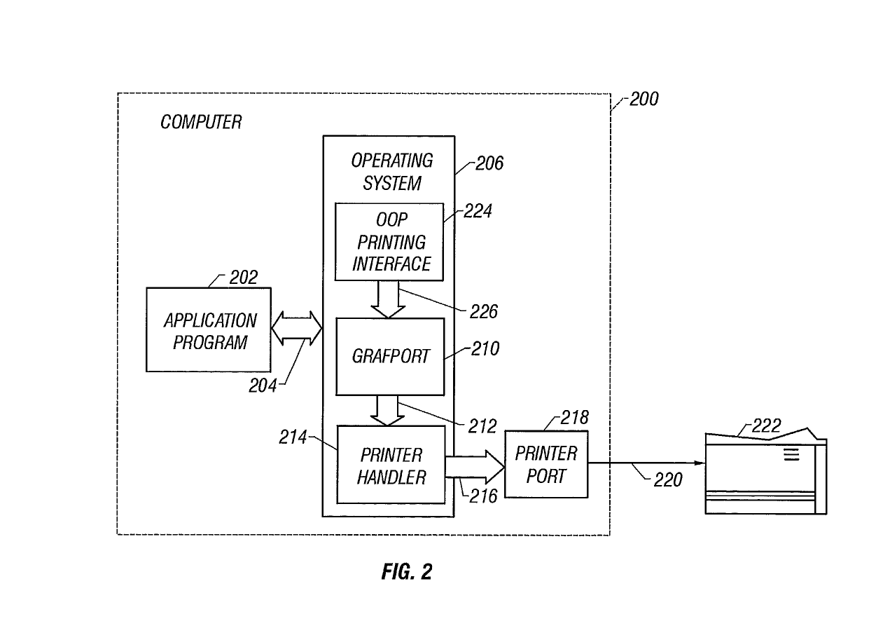

FIG. 2 shows a schematic overview of a computer system, shown generally as a dotted box 200, having an application program 202 and an operating system 206 to control and coordinate the operations of the computer. Application program 202 communicates with operating system 206 as indicated by arrow 204 to print information. This dual program system is used on many types of computers systems ranging from mainframes to personal computers.

The printing interface 224 responds to a series of simple commands generated by application program 202 in order to perform various formatting and pagination functions. The formatted, printable information is then transmitted to a grafport 210 as indicated schematically by arrow 226. While it is possible for application program 202 to communicate directly with grafport 210, it is not contemplated that most applications will do this unless special procedures are needed.

In any case, the information flows through grafport 210, and as indicated by arrow 212, is provided to a printer handler 214. Printer handler 214 is similar to printer drivers. However, the printer handler is “intelligent” and offers some additional capabilities that will be described herein. Essentially, printer handler 214 processes the incoming data stream indicated by arrow 212 and adds the necessary printer commands to control the associated printer schematically illustrated as printer 222. The reformatted data is provided, as indicated by arrow 216, to a printer port 218 that converts the data into electrical signals that are sent over cable 220 to printer 222. Printer 222 usually contains an “imaging engine” which is a hardware device or a ROM-programmed computer which takes the incoming information stream and converts it into the electrical signals necessary to drive the actual printing elements. The result is a “hard copy” output on the selected medium.

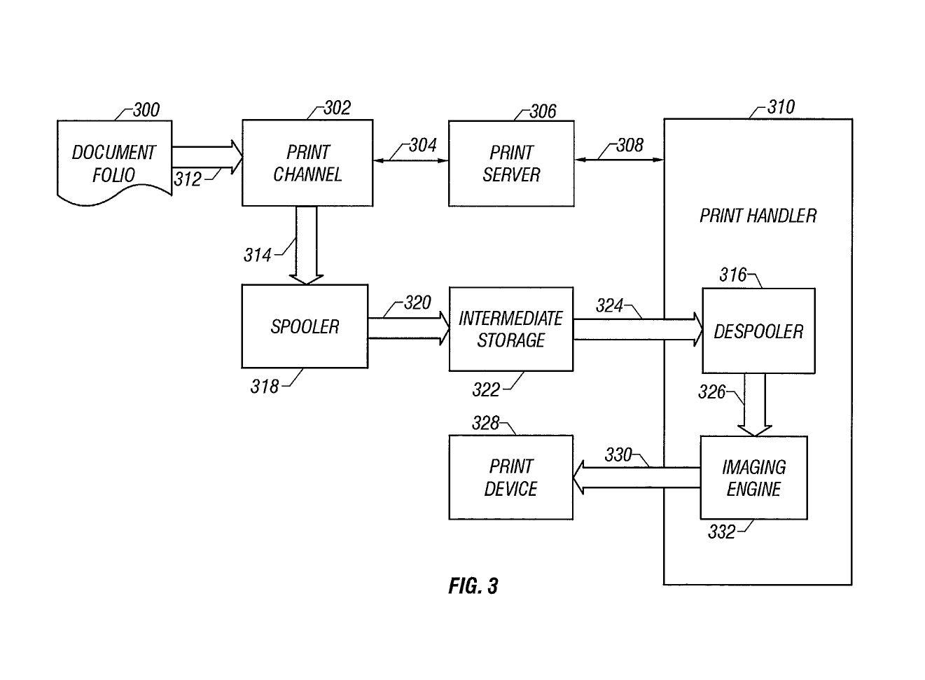

The actual mechanism by which a document generated by the printing interface 224 is transmitted to printer 222 is shown in more detail in FIG. 3. In particular, printing interface 224 (as will hereafter be described in detail) generates an entity called a document folio shown schematically as document folio 300 in FIG. 3. The document folio may consist of text, graphics or a combination of the two, all formatted and arranged in a manner specified by the application program. The document folio information is provided, as indicated by arrow 312, to a print channel 302. Print channel 302 is an object that is created to transport the information to an appropriate printer. Print channel uses a print job description and a printer identification provided by the application program to transmit the printable information to the appropriate printer.

More specifically, after the print channel 302 receives a printing job, it transmits the printable information to a spooler program 318 as indicated by arrow 314. Spooler 318 receives the incoming information stream and stores it, in incoming order, in an intermediate storage location 322 as indicated by arrow 320. Print channel 302 then sends a notification to a print server program 306 via a link 304, which notification informs print server program 306 that a new print job exists. The print server program 306 is a standard program that monitors all print jobs that have been created and also checks the available printers to determine their status.

Once a print job has been completely spooled or stored in intermediate storage 322, the print server 306 notifies a printer handler 310 by means of a link 308. The printer handler 310 is a type of printer driver that controls and drives a specific printer. The printer handler's purpose is to convert text and graphic information into printer readable form for any particular printer type. Typically, a printer handler can only process one print job and any other jobs that are created and directed towards the associated printer are queued for later processing. The printer handler contains a despooler program 316 that retrieves the spooled data from intermediate storage 322 (as indicated by arrow 324) and provides the information, as indicated by arrow 326, to an imaging engine 332. The imaging engine 332 converts the incoming data stream into the command signals that are necessary to drive the printing elements to produce the final printed document. The commands, indicated schematically by arrow 330, are provided to the actual print device indicated by box 328 for printing.

Once a print job is completely printed, the printer handler 310 checks its queue for another print job and, if a job is present, begins processing it. Alternatively, if there are no new print jobs to process, the printer handler becomes inactive. After a particular print job is completed, the information stored in intermediate storage in 322 is deleted and the storage is reclaimed. As an option, the storage can be retained until a user explicitly deletes the storage.

The desktop printer is the only user visible part of the printer. All user actions (commands) related to the printer are handled by the operating system. When a document is to be printed, it is dragged to the printer icon (or the Print item is selected from the system wide menu). This starts the printing process by first spooling the document by packaging it as a print job. Spooling is a process of streaming the graphic description of a document to the disk so it can be imaged later (possibly in a different task) to the actual printing device represented by the desktop printer. The spooled print job is stored in the printer's persistent data that consists mainly of the print job queue and the printer's dynamic configuration. After the print job is spooled, the printer handler is sent a message that there is a print job for it to process. The printer handler picks up the print job, despools it, converts it to the printer's native imaging model and sends it to the printer.

There is one printer handler task per physical printer. The printer handler consists of a dispatcher and an imaging task. The dispatcher is a task that handles requests to print jobs and sends them to the imaging task so that the server task is free to handle other requests (more print jobs, status queries, notification, etc.). The printer handler architecture allows for more than one task working on print jobs. Instead of having only one imaging task, the printer handler dispatcher can have a pool of tasks that access the job queue and pick up a job to process. This way, the printer handler can be processing multiple jobs at the same time. If the target printer can accept only one job at a time, only one imaging task will be talking to it at a given time. The multiple imaging tasks model works well when the destination is a spooler that can accept more than one job at a time. Each job in the queue knows the task that is processing it so that functions like “abort” and “pause” will operate properly.

The printer handler imaging task receives one job at a time. It uses the developer customizable imaging objects to convert the source description of the document into a stream of data targeted for a particular printer. The imaging task obtains a spool stream from the print job and passes it to the printer device object. The printer device extracts individual pages out of the print run and converts the individual pages into the printer's imaging model. The imaging objects also perform the task of mapping the attributes requested by the print job (page size, media, color, fonts, etc.) to features actually available on the printer. This processing is achieved by consulting the printer's dynamic state maintained by the printer handler.

The printer handler is responsible for keeping track of the printer's persistent data, in particular, its job queue and dynamic state. The dynamic state contains things like the current media/tray setting, current color mode (2, 3 or 4 colors), etc. The printer state, which is part of the printer model's store, is updated when the printer handler images a job to it and finds that the state has changed. This scheme works when the printer handler has two-way communication available with the printer. In cases when two-way communication is not available, the printer handler will rely on the printer's static configuration.

One of the capabilities of the printer handler is to report normal progress information to the user as a print job progresses. There are two types of statuses that a printer handler might want to report. The first is the global status of the job, for example, “Processing page 3 of 50”, or “Printing 4th out of 10 copies”, etc. This type of global job status is common for all printers and can be provided easily by the framework. The second kind of status is one that comes directly from the printer, for example, “user: Jay Patel; job: Printer Handler ERS; status: busy; source: AppleTalk”. Some printers may not report this type of status at all.

User notification is given in cases where there is a problem with printing. This may be a result of a printer out of paper, a paper jam, communication error, PostScript error, a plotter needs new/different set of pens, printer is out of ribbon, etc. For some of these situations, the user must be notified and the printing process can continue once the problem is rectified. There are cases, however, where the printer may not be able to say that the problem is fixed. In such cases, a notification must be given to the user and the printing process must wait until the user says it's OK to continue.

Networked printers are basically the same as a local printer except that the communications channel must use a specific network protocol. The present invention can be implemented on printers using protocols based on NPA (Network Printing Architecture), TCP/IP, PAP protocol, and Novell IPX based print servers.

In accordance with the present invention, the operating system provides an interface, preferably a graphical user interface, that allows the user to manage a plurality of print jobs that are scheduled to be printed and are present in the print queue of the printer handler. In particular, the interface allows for displaying the print jobs in a first scheduled print order according to the print queue, which is typically in the order that the print jobs were received by the printer handler. The user can reschedule one or more of the print jobs into a second scheduled print order, presumably reflecting the priority that the user assigns to each job. The rescheduling can be accomplished in various manners, such as ranking the order of the jobs, clicking and dragging icons that represent the print jobs into the desired order, or merely pausing low order jobs without pausing the higher priority jobs. Many other ways of effectively communicating the rescheduling command to the printer handler can be envisioned. The printer handler then provides the facility of printing the prints jobs in the second scheduled print order.

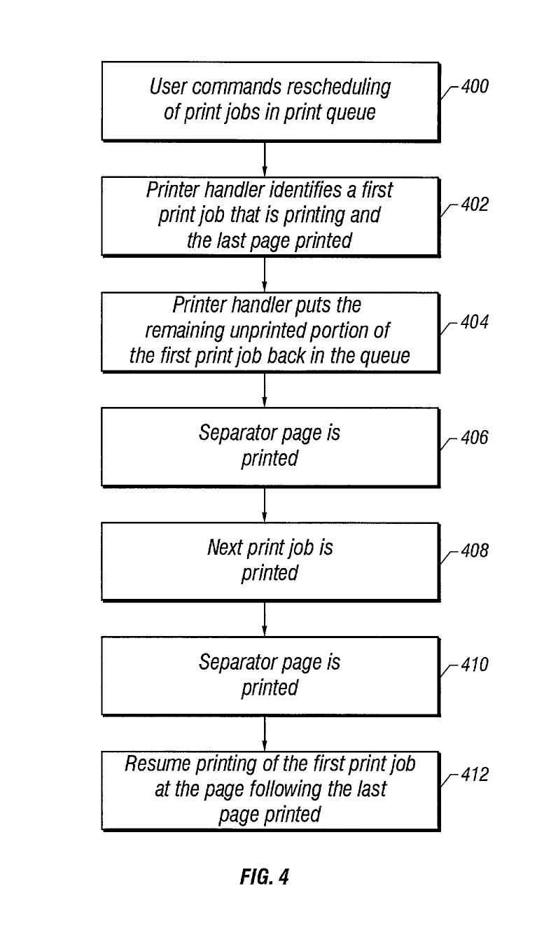

FIG. 4 is a flowchart illustrating the steps of pausing a first print job or advancing a second print job. In state 400, the user issues a print job rescheduling command, presumably through a graphical user interface, to the printer handler. In state 402, the printer handler identifies a first print job that is printing and the last page of that job that has been, or is still being, printed. In state 404, the printer handler instructs the print device to complete the printing of the current page in the current print job and to return the remaining portion of the first print job to the queue. The remainder of the paused print job can be rescheduled, such as by placing it back in the print queue, because the printer handler can track the status of the print job, including identifying the last page printed from a paused print job. It is especially beneficial for the printer handler to identify either the last page printed or the next page that is to be printed so that only the remaining portion of the first print job is queued, thereby avoiding duplicate printing of pages and avoiding a requirement that the user must resend the print job. In optional state 406, the printer handler causes a separator page to be printed. In state 408, the next print job in the print queue is sent by the printer handler to the print device to be printed. It is important to note that this second print job is subject to pausing as was the first job and so forth. In an additional optional state 410, the printer handler causes a second separator page to be printed. In this manner, the paused print job and the advanced print job can be easily parsed by a visual inspection of the printer output tray. In state 412, the printer resumes printing of the first print job at the page following the last page previously printed.

An alternative to rescheduling through direct interaction with a user interface to the printer handler is to identify certain jobs, either by type, source or an urgency code, to automatically skip the job to the front of the print queue, thereby pausing any job that is currently printing. Conversely, certain other jobs can be identified, either by type, source or a low urgency code, to automatically pause for other jobs that may come into the print queue after the relevant print job. For example, huge print jobs could be automatically given a lower priority of printing by the print manager without any user intervention required.

As referred to above in states 406 and 410, the printer handler may optionally be programmed to execute some type of separator command to the print device between any job or portion of a job that has been paused. The separator command would typically cause a separator sheet to pass through the printer to facilitate the user in determining where the first portion of the first (paused) print job ended and where the second portion of the first (paused) print job began. In multi-tray printers, the separator command would preferably draw from a special tray loaded with colored paper to facilitate easy visual separation of the print jobs. Alternatively, or in combination with the colored sheets, the printer handler may print status information on the separator sheet. The separator sheet print status information would preferably include identification of the print job or portion of the print job that either precedes or follows the separator sheet. Alternatively, if the print device has multiple output trays, such as a combination printer and photocopier, then the separator command may be simply to send the first and second print jobs to different output trays without need for a separator sheet.

A further optional feature of the present invention is directed to avoiding job starvation where a user is “starved” from print services, either because the user's print job is very low priority or others' print jobs are a much higher priority. Preferably, the user interface with the printer handler will provide the capability for the user to specify that a job could not be paused, held or otherwise kept from printing for more than a setpoint time period or setpoint number of printed pages.

It will be understood from the foregoing description that various modifications and changes may be made in the preferred embodiment of the present invention without departing from its true spirit. It is intended that this description is for purposes of illustration only and should not be construed in a limiting sense. The scope of this invention should be limited only by the language of the following claims.

1. A method for managing a plurality of print jobs scheduled to be printed, the method comprising:
displaying the print jobs in a first scheduled print order;
rescheduling the print jobs in a second scheduled print order; and
printing the print jobs in the second scheduled print order.

2. The method of claim 1, further comprising:
generating the plurality of print jobs using one or more application programs running in a computer that is in communication with one or more printers.

3. The method of claim 2, further comprising:
spooling the plurality of print jobs onto a storage device of the computer to form the first scheduled print order.

4. The method of claim 1, wherein the print jobs are rescheduled in response to commands initiated by a user.

5. The method of claim 1, further comprising:
pausing at least one of the print jobs; and
printing another of the print jobs that was later in the schedule print order.

6. The method of claim 5, further comprising:
resuming printing of the paused print jobs.

7. The method of claim 6, further comprising:
printing a separator page with print job information each time a print job is resumed.

8. The method of claim 6, further comprising:
printing a separator page before and after the step of printing another of the print jobs.

9. The method of claim 1, wherein the step of rescheduling the print jobs further comprises prioritizing the print jobs.

10. The method of claim 1, further comprising the step of:
displaying print status information during a print operation.

11. A method for pausing printing of a first multiple-page print job, the method comprising:
printing a first portion of the first print job;
receiving a second print job;
identifying and queing a second unprinted portion of the first print job;
printing the second print job; and then
printing the second unprinted portion of the first print job.

12. The method of claim 11, further comprising:
allowing a last page in the first portion of the first print job to complete printing, wherein the second unprinted portion of the first print job is identified as every page in the first print job following the last page to complete printing.

13. The method of claim 12, wherein the second print job has a higher priority than the first print job.

14. The method of claim 12, wherein the first print job is automatically assigned a low priority if the print job exceeds a page number setpoint.

15. A computer program product including instructions embodied on a computer readable medium, the instructions comprising:
displaying instructions for displaying the print jobs in a first scheduled print order;
rescheduling instructions for rescheduling the print jobs in a second scheduled print order; and
printing instructions for printing the print jobs in the second scheduled print order.

16. The computer program product of claim 15, further comprising:
generating the plurality of print jobs using one or more application programs running in a computer that is in communication with one or more printers.

17. The computer program product of claim 16, further comprising:
spooling the plurality of print jobs onto a storage device of the computer to form the first scheduled print order.

18. The computer program product of claim 15, wherein the print jobs are rescheduled in response to commands initiated by a user.

19. The computer program product of claim 15, further comprising:
pausing at least one of the print jobs; and printing another of the print jobs that was later in the schedule print order.

20. The computer program product of claim 19, further comprising:
resuming printing of the paused print jobs.

21. The computer program product of claim 20, further comprising:
printing a separator page with print job information each time a print job is resumed.

22. The computer program product of claim 20, further comprising:
printing a separator page before and after the step of printing another of the print jobs.

23. The computer program product of claim 15, wherein the step of rescheduling the print jobs further comprises prioritizing the print jobs.

24. The computer program product of claim 15, further comprising the step of:
displaying print status information during a print operation.

25. A system comprising:
a memory device having one or more printer handler therein for maintaining information relating to a plurality of print jobs;
a processor in communication with the memory device, the processor configured to:
display the print jobs in a first scheduled print order;
reschedule the print jobs in a second scheduled print order; and
print the print jobs in the second scheduled print order.

26. The system of claim 25, wherein the processor is further configured to:
generate the plurality of print jobs using one or more application programs running in a computer that is in communication with one or more printers.

27. The system of claim 26, wherein the processor is further configured to:
spool the plurality of print jobs in the memory to form the first scheduled print order.

28. The system of claim 25, wherein the print jobs are rescheduled in response to commands initiated by a user.

29. The system of claim 25, wherein the processor is further configured to:
pause at least one of the print jobs; and
print another of the print jobs that was later in the schedule print order.

30. The system of claim 29, wherein the processor is further configured to:
resume printing of the paused print jobs.

31. The system of claim 30, wherein the processor is further configured to:
print a separator page with print job information each time a print job is resumed.

32. The system of claim 30, wherein the processor is further configured to:
print a separator page before and after the step of printing another of the print jobs.

33. The system of claim 25, wherein the processor is further configured to:
prioritize the print jobs.

34. The system of claim 25, wherein the processor is further configured to:
display print status information during a print operation.
